(19) United States
(12) Patent Application Publication
(10) Pub. No.: US 2022/0215214 A1
(43) Pub. Date: Jul. 7, 2022

(54) METHOD FOR EVALUATING AN INFRARED SIGNATURE

(71) Applicant: DEUTSCHE INSTITUTE FÜR TEXTIL-UND FASERFORSCHUNG DENKENDORF, Denkendorf (DE)

(72) Inventors: Tobias HECHT, Stuttgart (DE); Reinhold SCHNEIDER, Göppingen (DE); Peter STEIGER, Schorndorf (DE)

(21) Appl. No.: 17/609,646

(22) PCT Filed: May 7, 2020
(86) PCT No.: PCT/EP2020/062681

§ 371 Date: Nov. 8, 2021

(30) Foreign Application Priority Data
May 8, 2019 (DE) 10 2019 111 914.6

(51) Int. Cl. G06K 19/06; G06V 10/88; G06V 10/143

(52) U.S. Cl. CPC G06K 19/0614; G06V 10/143; G06V 10/898

(57) ABSTRACT

A method for evaluating an infrared signature present on an object surface, which signature preferably forms a two-dimensional code. Furthermore, a monochrome or multicolour pattern, which reflects light in the visible wavelength range, can be present on the object surface. The infrared signature only absorbs light in the infrared range and can consequently be detected by means of an IR camera. In the method, an infrared light source is switched on and the infrared signature is illuminated with infrared light and an original image is recorded with an infrared camera in this state. The original image or a further-processed image based thereon is then filtered by a high-pass filter, the contrast in the image being increased indirectly or directly after the high-pass filtering. The infrared signature can finally be evaluated in the image processed in this way.

### CROSS REFERENCE TO RELATED APPLICATIONS

This application is a National Stage application of PCT/EP2020/062681, filed on May 7, 2020, which claims the benefit of German Application No. 102019111914.6, filed on May 8, 2019, the contents each of which are incorporated by reference in their entirety herein.

### BACKGROUND

The invention refers to a method for evaluation of an infrared signature applied to an object surface. In addition, the method refers to the use of a mobile device such as a mobile phone, a mobile computer or another mobile communication device and/or computer configured to be handheld for carrying out this method.

DE 10 2013 100 662 A1 describes a marker composition by means of which an infrared signature can be applied on an object surface, e.g. by means of printing. The composition comprises an infrared absorbing component as well as a carbon derivative. By means of such a marker composition an infrared signature can be created that can be subsequently detected by means of a respective camera. The marker composition is also described in the final report “Invisible infrared sensitive coating (INCODE)” dated Sep. 29, 2014, that was written in the context of the program for support of the Industrial Common Research (IGF). A summary of this marker composition is also contained in the overview sheet “Brand protection by the use of invisible markings” that was created by the applicant and distributed at trade fairs.

An infrared signature is also known from the final report referring to the joint project “SECUTEX” of Frauenhofer Institut for Manufacturing Engineering and Automation.

WO 2004/003070 A1 describes bright and transparent oxidic and sulphidic semi-conductor materials or particular substrates coated with these semi-conductor materials as hardening and/or drying additives and/or for increase of varnishes and printing colors. By these means also IR-markings can be manufactured.

A security ink is known from WO 2007/132214 A1 that contains infrared light absorbing metals or metal compounds such as, for example metal salts, metal oxides or metal nitrides.

The above-mentioned marker compositions, inks or colors can be used in the context of the present invention.

A method for creating and scanning a two-dimensional QR-Code is known from the article Meruga “Security Printing of covert quick response codes using upconverting nanoparticle inks”, Nanotechnology 23 (2012) 395201, IOP Publishing Ltd., doi: 10.1088/0957-4484/23/39/395201. The QR-code is printed with ink in the non-visible infrared range and subsequently excited by means of an infrared diode laser. In doing so, a luminescence of the QR-code is effected that can be subsequently detected and evaluated by means of a mobile phone or smartphone.

Non-visible infrared signatures have the advantage that products can be characterized therewith while avoiding that the identification is readily visible. The use of such an infrared signature is, e.g. the identifying of products in order to be able to evaluate the originality or genuineness thereof.

The detection and evaluation of such identifiers requires so far, however, costly and complex devices and thus hinders the acceptance of infrared signatures in the market. Thus, a simple possibility would be desirable in order to be able to detect and evaluate such infrared signatures with usual means in an inexpensive manner.

### BRIEF SUMMARY

Disclosed is amethod for evaluation of an infrared signature applied on an object surface comprising the following steps: switching on an infrared light source and illuminating the infrared signature with infrared light; capturing of an initial image by means of an infrared camera; creating a high-pass filtered image based on the initial image by means of high-pass filtering in order to mitigate or eliminate an infrared light spot that is present in the initial image on the infrared signature; creation of a high-contrast image by increasing a contrast in an image based on the high-pass filtered image; and evaluating the infrared signature in an image based on the high-contrast image.

According to the present disclosure, an infrared signature applied to an object surface is evaluated. Preferably, the infrared signature is a two-dimensional code, such as a bar code, a quick response code (QR-code) or a data matrix code. The infrared signature has, for example, a material composition, as described in DE 10 2013 100 662 A1 or in WO 20047/003070 A1 or in WO 2007/132214 A1. Particularly, the infrared signature does not emit light in the visible spectral range. Preferably, the infrared signature absorbs light having a wavelength in the wavelength range between approximately 780 nm to approximately 1 μm. This IR-absorption can be detected by means of an IR-camera. The infrared signature distinguishes from the surrounding area on the object surface and appears particularly darker in a detected image.

In the method an infrared light source, particularly an infrared light emitting diode is switched on and illuminates the infrared signature with infrared light. In doing so, an illuminated area is created on the object surface that can be formed by at least one continuous infrared light spot.

During the illumination of the infrared signature with the infrared light source an initial image is captured with an infrared camera. This initial image is subsequently processed or pre-processed in order to be able to evaluate it then with available standard programs or standard applications.

Based on the initial image a high-pass filtered image is created by means of high-pass filtering. Due to the high-pass filtering, the illuminated area or the at least one infrared light spot that was created by the illumination with the infrared light source in the initial image, is mitigated or eliminated. The high-pass filtered image can be directly created from the initial image. As an alternative, the initial image can be processed by one or more imaging steps first, prior to carrying out the high-pass filtering.

Based on the high-pass filtered image, a high contract image is created subsequently in that the contrast is increased in an image based on the high-pass filtered image. Preferably, the contrast is increased directly in the high-pass filtered image in order to create the high contrast image. As an alternative thereto, one or multiple additional imaging steps can be carried out after high-pass filtering and prior to increasing the contrast.

Finally, the visible infrared signature is evaluated in an image that is based on the high contrast image. Preferably directly, a high contrast image can be used as result image for this evaluation. As an alternative to this, the high contrast image can be subject to one or multiple image processing steps in order to create the result image used for evaluation.

By means of this method, it is possible to use common cameras and infrared light emitting diodes and available programs or applications to evaluate the infrared signature. It is particularly possible to carry out the claimed method by means of a mobile phone, a mobile computer or another mobile device or mobile communication device and/or computer configured to be handheld that comprises an infrared camera, an infrared illumination and a computing unit. Such a mobile device is preferably battery supplied and can be, for example, a smartphone, a tablet, notebook or laptop. On such mobile devices available standard applications can be readily used due to the inventive processing of the image in order to evaluate an infrared signature. The infrared cameras and infrared light sources that are available as a standard are sufficient for this purpose.

The infrared camera and/or infrared illumination can be immovably integrated in the mobile device or can be communicatively connected with the computing unit of the mobile device by means of an interface, e.g. a USB-interface or another standardized interface, in a wired or wireless manner.

The infrared camera can be particularly configured to detect and image light in the non-visible infrared spectral range and in the visible spectral range. Preferably, the infrared camera is configured to detect and image light in the non-visible infrared spectral range up to a wavelength of maximum 50 μm or maximum 20 μm or maximum 10 μm or maximum 3-5 μm. Particularly, the infrared camera is able to capture and image light in the non-visible range from 780 nm to 1.4 μm or 3.0 μm. The initial image therefore also contains image components with wavelengths smaller than 780 nm. Thus, the camera is preferably configured to capture and image light in the Near Infrared Range (NIR). Preferably, the initial image does not contain image components with wavelengths in the Far Infrared Range (FIR) having wavelengths larger than 50 μm.

The inventive method can guarantee a reliable evaluation of the infrared signature inspite of the use of standard hardware.

In addition to the infrared signature at least one color and/or pattern in the visible spectral range can be present on the object surface. The object surface is thus particularly not uniformly white, but can comprise a pattern in one color or multiple colors.

An input filter is preferably present. The input filter is configured to filter light in the light path between the object surface and the infrared camera and to allow light in the non-visible infrared spectral range, i.e. with wavelengths of at least 780 nm to pass and reduce or eliminate light in the visible spectral range. Preferably, the input filter can have light with a wavelength of less than 780 nm not to pass or only to a negligible small amount to the infrared camera. In doing so, also infrared cameras can be used that detect and image light in the visible spectral range and particularly in the transition area between the Near Infrared Range (NIR) and the visible spectral range. The input filter is arranged in the light path between the object surface and the infrared camera. For example, it can be formed by a foil and can particularly be adhesively attached on or over the objective lens of the infrared camera.

It is preferred, if the infrared light source continuously emits infrared light and illuminates the infrared signature during capturing of the initial image. Particularly, the intensity of the emitted infrared light is constant during the entire exposure time, i.e. during the whole capturing of the initial image. The imaging area of the infrared camera can be larger than the illuminated area or the at least one infrared light spot that is created by the infrared light source on the object surface during illumination of the infrared signature.

In an advantageous embodiment of the method a blurred image can be created by means of blurring, particularly Gaussian filtering and/or low-pass filtering of the initial image. In this configuration it is also possible to carry out the high-pass filtering in a manner such that a difference image is created from the initial image and the blurred image. The difference image can subsequently be amplified in that the pixel values are multiplied by a factor larger than 1 and/or added with a summand.

The used filter for blurring, particularly Gaussian filter and/or low-pass filter, can also be applied multiple times on the image to be filtered.

During the high-pass filtering and/or the blurring (e.g. Gaussian filtering and/or low-pass filtering) color information possibly contained in the pixels is ignored. Only the grey-scale values of each pixel are influenced by the filtering.

It is also possible to carry out the blurring not on the initial image, but at any other point during the imaging method. For example, the high-pass filtered image can be subject to blurring. Alternatively, also the high contrast image can be subject to blurring.

The blurring can, e.g. be executed by means of a low-pass filter or a Fourier transformation. In addition or as an alternative, high-pass filtering can be carried out by means of a high-pass filter or a Fourier transformation. Instead of a separate low-pass filtering and a separate high-pass filtering, a band pass filter can also be used. By means of the Fourier transformation the blurring as well as the high-pass filtering can be carried out. The Fourier transformation can, for example, be realized as Fast Fourier transformation (FFT).

As already explained, the above-described method can be carried out by means of a mobile device. The method is suitable for using standard components, such as a standard infrared camera, a standard infrared illumination and a standard application for evaluating the captured infrared signature. In this manner a particularly simple and cheap detection and evaluation of the infrared signature is possible. The high contrast image or a result image based thereon can be transmitted to a standard application for evaluation of the infrared signature.

### BRIEF DESCRIPTION OF THE DRAWINGS

Advantageous embodiments of the invention are obtained from the dependent claims, the description and the drawings. In the following, preferred embodiments of the invention are described in detail based on the attached drawings. The drawings show:

FIG. 1 a highly schematic illustration of a mobile device having an infrared camera and an infrared illumination,

FIG. 2 an object surface having a pattern and a schematically illustrated infrared signature,

FIG. 3 a block-diagram-like illustration of the mobile device of FIG. 1 during the capturing of an initial image of the object surface of FIG. 2,

FIG. 4 a flow diagram of an embodiment of an inventive method,

FIG. 5 a schematic illustration of a high-pass filter in the form of a difference filter,

FIG. 6 a schematic illustration of a low-pass filter in the form of a difference filter,

FIG. 7 a block-diagram-like illustration for realization of a high-pass filtering of an initial image and a blurred image,

FIG. 8 an exemplary illustration of an initial image, wherein the infrared signature is surrounded by dashed lines in the initial image,

FIG. 9 an exemplary illustration of a high-pass filtered image, wherein the infrared signature in the high-pass filtered image is surrounded by dashed lines,

FIG. 10 an exemplary illustration of a high contrast image after increasing the contrast in the high-pass filtered image according to FIG. 9 and

FIG. 11 an exemplary illustration of a blurred image that was obtained from the high contrast image by blurring and serves as result image for the evaluation of the infrared signature.

### DETAILED DESCRIPTION

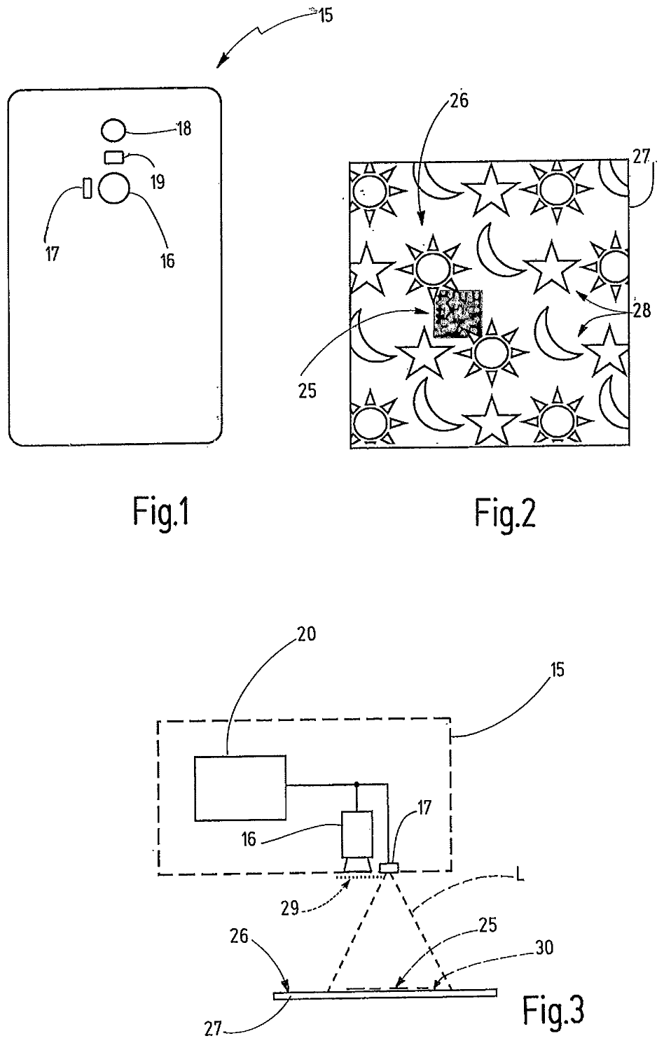

A mobile device 15 is schematically illustrated in FIGS. 1 and 2 that can be formed by a mobile phone or smartphone or a tablet personal computer for example. The mobile device 15 has an integrated infrared camera 16 as well as an integrated infrared light source 17 according to the example. The infrared light source 17 can be formed by an infrared LED. The infrared light source 17 is asymmetrically configured or arranged relative to the optical axis of the infrared camera 16. The mobile device 15 can comprise in addition a common camera 18 for visible light as well as a light source 19 for visible light. The light source 19 serves as flash for illumination during capturing of images with the camera 18.

Preferably, one single infrared light source 17, e.g. one single infrared light emitting diode is provided.

The infrared camera 16 and the infrared light source 17 are communicatively connected with a processor 20 of the mobile device 15. The processor 20 can be configured to execute programs and applications of the mobile device 15, particularly an application for evaluation of a two-dimensional code, such as a QR-code, a bar code or a data matrix code. The communication connection between the processor 20 and the infrared camera 16 and the infrared light source 17 can be established in a wireless and/or wired manner.

The infrared camera 16 and the infrared light source 17 are arranged in a housing of the mobile device 15 according to the example. In another embodiment the processor 20 can have a communication interface to which the infrared camera 16 and the infrared light source 17 can be connected. In this case, the infrared camera 16 and/or the infrared light source 17 can be arranged as external units outside of the housing of the mobile device 15 in which the processor 20 is arranged. For example, an external infrared camera 16 and an external infrared illumination 17 can form a unit that can be commonly connected to an interface on or in the housing of the mobile device 15. In doing so, the at least one external unit can communicate with the processor 20 arranged in the housing of the mobile device 15.

The infrared camera 16 is configured to detect light in the visible spectral range and in the non-visible infrared range and to image it in a captured image. Infrared cameras 16 that can also capture light in the visible spectral range are frequently seen in standard devices, because it is in fact desired to capture not only light in the infrared range, but—as far as present—also residual light that is still present in the visible range in order to optimally use the available light conditions for the initial image. For example, the infrared camera 16 can be configured to capture and image light in the IR-A range of 780 nm to approx. 1.4 μm. In addition or as an alternative, the infrared camera 16 can also be configured to image light in the spectral range with a wavelength of approximately 1.4 μm to 3.0 μm (IR-B). Preferably, the infrared camera 16 is configured to image light in the spectral range with wavelengths of maximum 50 μm or maximum 20 μm or maximum 10 μm or maximum 3-5 μm.

The mobile device 15 serves for detection and evaluation of an infrared signature 25 that is particularly apparent in FIGS. 2, 10 and 11. The infrared signature 25 forms a two-dimensional code, e.g. a Quick Response code (QR-code), a bar code or the like. Such a code contains encrypted or coded information by means of graphical elements that can be read by means of the mobile device 15.

The infrared signature 25 is applied on an object surface 26 of an object 27, particularly printed. The infrared signature 25 is not visible for the human eye during radiation with light in the visible wavelength range. The infrared signature 25 absorbs preferably light in the wavelength range of at least 780 nm. This IR-absorption can be detected by means of an IR-camera. Additional illustrations, patterns, images, forms, symbols or the like in one or multiple colors in the visible spectral range can be illustrated on the object surface 26 of the object 27 beside the infrared signature 25. Only by way of example, schematic patterns in form of suns, moons and stars are illustrated in FIG. 2. As apparent from FIG. 2, the infrared signature 25 and the pattern 28 overlap on the object surface 26.

Because the infrared camera 16 is configured to capture and image light in the wavelength range of the visible light as well as the non-visible infrared range, the detection and evaluation of the infrared signature 25 is affected by the pattern 28. In order to counteract to this, an input filter 29 is present. The input filter 29 is placed on or over the objective lens of the infrared camera 16 and can be formed, for example, by means of a foil. The input filter 29 is thus located in the light path between the object surface 26 having the infrared signature 25 and the infrared camera 16. The input filter 29 is configured to allow light in the non-visible infrared range having a wavelength of at least 780 nm to pass through and to block the light with wavelengths smaller than 780 nm as far as possible completely. In doing so, it is avoided that the pattern 28 affects the detection and evaluation of the infrared signature 25, but to allow that a simple and inexpensive infrared camera can be used that also images light in the visible wavelength range.

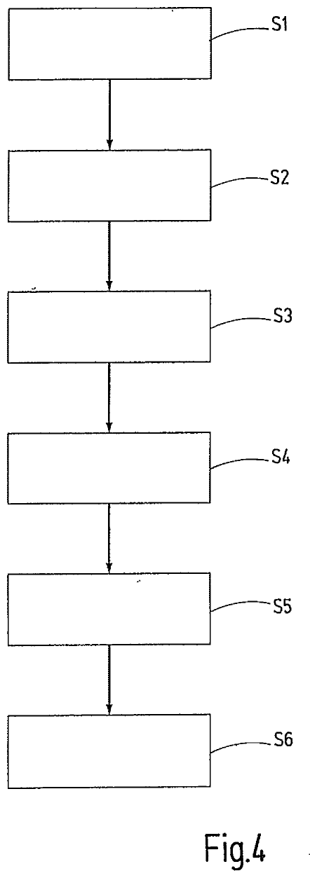

By means of the mobile device 15, a method is executed for detection and evaluation of the infrared signature 25, an embodiment of which is illustrated in the flow diagram of FIG. 4.

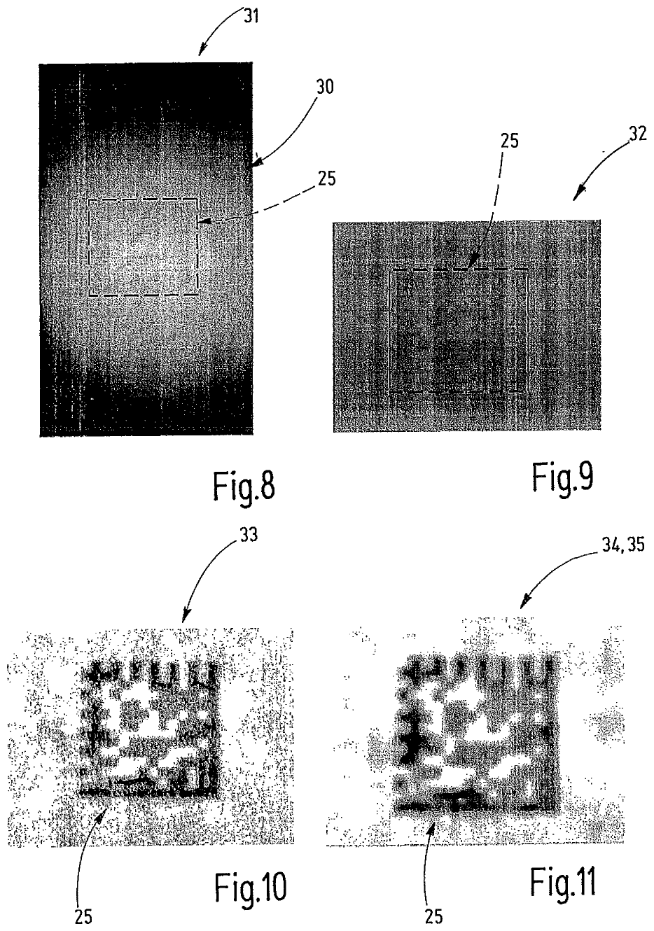

In a first method step S1 the infrared light source 17 is switched on. In the switched on condition the infrared light source 17 continuously emits infrared light L. By emission of the infrared light L on the object surface 26, an area illuminated with infrared light L is created that can also be denoted at infrared light spot 30. The infrared light spot 30 is illustrated in FIG. 8 by an elliptical bright area. The infrared light spot 30 preferably illuminates an area on the object surface 26 that is larger than the infrared signature 25 that is located within the infrared light spot 30 (FIG. 8).

In a second method step S2 an initial image 31 is captured by means of the infrared camera 16. An embodiment of the initial image 31 is illustrated in FIG. 8. During the capturing of the initial image 31, i.e. during the entire exposure time of the infrared camera 16, the infrared light source 17 remains continuously switched on. Preferably, the intensity of the infrared light L emitted by the infrared light source 17 is constant during the entire capturing of the initial image 31.

As it can be seen based on the exemplary initial image 31 of FIG. 8, the infrared signature 25 shown in the initial image 31 is outshined by the infrared light spot 30 and is hardly or not recognizable. For this reason and for sake of clarity a dashed frame was inserted in FIG. 8 within which the captured infrared signature 25 is located.

In the embodiment the initial image 31 is thus subject to image processing in order to be able to evaluate the infrared signature 25 with usual applications or programs.

In the embodiment in a third method step S3 first a high-pass filtering of the initial image 31 is carried out and thus a high-pass filtered image 32 is created that is illustrated by way of example in FIG. 9. Also in this high-pass filtered image the infrared signature 25 is not or hardly recognizable due to the minor color differences or grey scale differences between adjacent pixels and thus for identification surrounded by dashed lines. As apparent by way of the example of the high-pass filtered image 32 in FIG. 9, the infrared light spot 30 is eliminated in the high-pass filtered image 32 due to the high-pass filtering.

Subsequent to the high-pass filtering the increase of the contrast in the high-pass filtered image 32 is carried out, whereby a high-pass filtered image 32 is obtained illustrated in FIG. 10 according to the example (fourth method step S4). In this high-contrast image 33 the infrared signature 25 can now already be recognized remarkably better. However, the high-contrast image 33 still contains high-frequent noise components that affect or impede the evaluation of the infrared signature. For this reason the high-contrast image 33 is subject to a blurring in a fifth method step S5, e.g. a Gaussian filtering and/or low-pass filtering and in doing so, from the high-contrast image 33 a blurred image 34 is created that forms a result image 35 according to the example.

The result image 35 is transmitted to a program or application that is executed by means of the processor 20 of the mobile device 15. The evaluation of the infrared signature 25 is carried out in a sixth method step S6. The application or program evaluates the infrared signature 25 and provides the information contained therein to the user, e.g. on a display of the mobile device 15. The information contained in the infrared signature 25 can also be provided to other programs or applications or can be transmitted by the mobile device 15 by means of wired and/or wireless communication connections to other devices or apparatus.

In the embodiment of the method according to FIG. 4 the blurred image 34 is used as result image 35. Alternatively to the illustrated method, blurring can also be carried out after capturing of the initial image 31 and prior to the high-pass filtering. It is also possible to carry out blurring after high-pass filtering and prior to increasing the contrast. Thus, the blurring can be carried out after the second method step S2 and prior to the sixth method step S6 at an arbitrary point of the method.

The increase of the contrast for creation of the high-contrast image 33 is carried out necessarily after high-pass filtering, because otherwise the increase of the contrast without preceding high-pass filtering would result in elimination of the infrared signature 25 contained in the initial image 31.

The application or program for carrying out the sixth method step S6, i.e. for evaluation of the infrared signature 25, operates preferably as follows:

First, the obtained result image 35 is transferred in a monochrome matrix. Subsequently, the image section is identified in which the two-dimensional code is contained. Then, for example, the amount of data of the code (number of contained information in Bit) can be determined, e.g. by means of the number of black-white transitions at the edge of the code. Finally, the contained information is read.

If the program or application for evaluation of the infrared signature should not recognize a usable two-dimensional code in the sixth method step S6, the method is preferably automatically repeated with the first method step S1. If after a predefined number of method routines still no usable two-dimensional code has been recognized in the infrared signature 25, a respective information can be output on the display of the mobile device 15. This information can also be transmitted to other devices or apparatus via a wireless and/or wired interface.

A difference filter is schematically illustrated in FIG. 5 by means of which a high-pass filtering can be carried out. In the embodiment the difference filter has a size of 3×3 pixels only by way of example. The difference filter can, however, also have a higher number of pixels. The number of pixels in height and width is uneven respectively. The central matrix field corresponds to the pixel of the image (e.g. the initial image 31) subject to the high-pass filtering that is modified in relation to the surrounding pixel in its pixel value. As illustrated in FIG. 5, the sum of the inserted filter values is equal to 0.

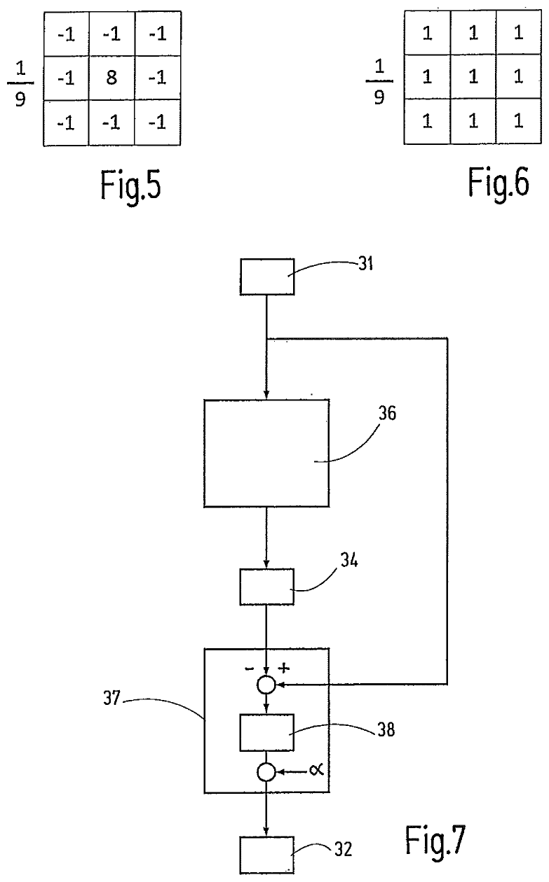

FIG. 6 schematically shows a difference filter that can be used as low-pass filter for an image (e.g. the high-contrast image 33) to be filtered. Thereby mean value is created. Instead of or in addition to the mean value creation, also a Gaussian filtering or the like can be carried out as blurring. Also, the low-pass filter can be selected larger instead of a size of 3×3 pixels, e.g. 4×4 pixels, 5×5 pixels or more. The low-pass filter can have an even or uneven number of pixels per side.

The high-pass filtering and blurring can be executed separately and separate from one another. Alternatively to this, it is also possible to carry out a band pass filtering in one single step.

For high-pass filtering and/or blurring also a Fourier transformation, particularly a fast Fourier transformation (FFT) can be realized.

In an embodiment the following filter parameters can be used in a resolution of the image of 1280×720 pixels:
high-pass filter: 167×167 pixels, adapted to the resolution;
contrast factor 20;
low-pass filter: 13×13 pixels and thus sufficiently small relative to the resolution of the image in order to avoid that the image information of the infrared code is eliminated.

In FIG. 7 also another possibility for high-pass filtering is illustrated. Thereby an image, e.g. the initial image 31, is subject to a low-pass filtering 36 first, such that from the initial image 31 the blurred image 34 is obtained. The blurred image 34 as well as the initial image 31 are then transferred to high-pass filtering 37. During this high-pass filtering 37 a difference image 38 is created that corresponds to the difference of the initial image 31 minus the blurred image 34. The difference image 38 can subsequently be amplified by addition with a summand or by multiplication with a factor α larger than 1.

During filtering color information potentially contained in the pixel is ignored. Only the grey scale values of each pixel is considered.

The invention refers to a method for evaluation of an infrared signature 25 present on an object surface 26 that preferably forms a two-dimensional code. In addition, a one-or multiple-colored pattern can be present on the object surface 26 that reflects light in the visible wavelength range. The infrared signature 25 absorbs light in the infrared range and is thus detectable by means of an IR-camera. During the method an infrared light source 17 is switched on and the infrared signature 25 is illuminated with infrared light L and an initial image 31 is captured by means of the infrared camera 16 in this condition. The initial image 31 or a further processed image based thereon is subsequently subject to a high-pass filtering, whereby directly or indirectly after the high-pass filtering, the contrast in the image is increased. Finally, an evaluation of the infrared signature 25 can be carried out in the image processed in this way.

### REFERENCE LIST

15 mobile device
16 infrared camera
17 infrared illumination
18 camera
19 light source
20 processor
25 infrared signature
26 object surface
27 object
28 pattern
29 input filter
30 infrared light spot
31 initial image
32 high-pass filtered image
33 high-contrast image
34 blurred image
35 result image
36 blurring
37 high-pass filtering
38 difference image
α factor
L infrared light
S1 first method step
S2 second method step
S3 third method step
S4 fourth method step
S5 fifth method step
S6 sixth method step

1. A method for evaluation of an infrared signature applied on an object surface comprising the following steps:
switching on an infrared light source and illuminating the infrared signature with infrared light;
capturing of an initial image by means of an infrared camera;
creating a high-pass filtered image based on the initial image by means of high-pass filtering in order to mitigate or eliminate an infrared light spot that is present in the initial image on the infrared signature;
creation of a high-contrast image by increasing a contrast in an image based on the high-pass filtered image; and
evaluating the infrared signature in an image based on the high-contrast image.

2. The method according to claim 1, wherein in addition at least one color and/or a pattern in the a visible spectral range is present on the object surface.

3. The method according to claim 1, wherein the infrared camera is configured to image light in a non-visible infrared spectral range and in the visible spectral range.

4. The method according to claim 3, wherein prior to entry in the infrared camera light is filtered by means of an input filter that is configured to allow light in the non-visible infrared spectral range to pass and to reduce or eliminate light in the visible spectral range.

5. The method according to claim 1, wherein the infrared camera is configured to image light in a non-visible infrared spectral range up to a wavelength of maximum 50 μm or maximum 20 μm or maximum 10 μm or maximum 3-5 μm.

6. The method according to claim 1, wherein the infrared light source continuously emits infrared light during capturing of the initial image.

7. The method according to claim 1, wherein a blurred image is created by blurring of the initial image.

8. The method according to claim 7, wherein the high-pass filtering is carried out in that a difference image is created from the initial image and the blurred image.

9. The method according to claim 1, wherein a blurred image is created by blurring of a high-pass filtered image.

10. The method according to claim 1, wherein a blurred image is created by blurring of the high-contrast image.

11. The method according to claim 6, wherein the blurring is carried out by means of a low-pass filter or a Gaussian filter or a Fourier transformation.

12. The method according to claim 1, wherein the high-pass filtering is carried out by means of a high-pass filter or a Fourier transformation.

13. The method according to claim 1, wherein the infrared signature is a two-dimensional code and evaluation of the infrared signature is carried out based on an application program to which the high-contrast image or an image based on the high-contrast image is transmitted.

14. Use of a mobile device comprising a processor that is communicatively connected with an infrared camera and an infrared illumination for carrying out the method according to claim 1.

15. Use of the mobile device according to claim 14, wherein the mobile device comprises an infrared camera and an infrared illumination installed in a housing of the mobile device.

16. Use of the mobile device according to claim 14, wherein the mobile device comprises at least one or exactly one external unit outside a housing of the mobile device having an infrared camera and an infrared illumination, wherein the external unit is communicatively connected with the processor in a wireless or wired manner.

17. The method according to claim 2, wherein the infrared camera is configured to image light in a non-visible infrared spectral range and in the visible spectral range.

18. The method according to claim 17, wherein prior to entry in the infrared camera light is filtered by means of an input filter that is configured to allow light in the non-visible infrared spectral range to pass and to reduce or eliminate light in the visible spectral range.

19. The method according to claim 18, wherein the infrared camera is configured to image light in a non-visible infrared spectral range up to a wavelength of maximum 50 μm or maximum 20 μm or maximum 10 μm or maximum 3-5 μm.

20. The method according to claim 19, wherein the infrared light source continuously emits infrared light during capturing of the initial image.
